(19) United States
(12) Patent Application Publication
(10) Pub. No.: US 2026/0023043 A1
(43) Pub. Date: Jan. 22, 2026

(54) SINGLE-ROD MEASURING CELL AND SENSOR CONTAINING THE SINGLE-ROD MEASURING CELL FOR STERILE APPLICATIONS

(71) Applicant: Endress+Hauser Conducta GmbH+Co. KG, Gerlingen (DE)

(72) Inventor: Thomas Höhne, Chemnitz (DE)

(21) Appl. No.: 19/273,741

(22) Filed: Jul. 18, 2025

(30) Foreign Application Priority Data
Jul. 18, 2024 (DE) 20 2024 120 250.5

(51) Int. Cl. G01N 27/333; G01N 27/30; G01N 27/31; G01N 27/327; G01N 27/36; G01N 27/403; G01N 27/416

(52) U.S. Cl. CPC G01N 27/333; G01N 27/301; G01N 27/31; G01N 27/327; G01N 27/36; G01N 27/4035; G01N 27/4161

(57) ABSTRACT

A single-rod measuring cell includes a plug-in head, a shaft, and an end that faces a medium during operation. The single-rod measuring cell comprises a measuring half-cell including a body formed from an electrically conductive metal or a metal alloy. The body is enclosed by an ion-selective enamel layer and an insulating enamel layer on at least a surface of the body, in contact with the medium during operation and the electrolyte solution. Also included is a tubular reference half-cell comprising an outer shell which at least partially encloses the measuring half-cell. The outer shell contains at least one diaphragm, and the reference half-cell contains a reference electrode and a reference electrolyte.

### CROSS-REFERENCE TO RELATED APPLICATION

The present application is related to and claims the priority benefit of German Patent Application No. 10 2024 120 250.5, filed on Jul. 18, 2024, the entire contents of which are incorporated herein by reference.

### TECHNICAL FIELD

The present disclosure relates to an electrochemical, such as a potentiometric, single-rod measuring cell and an electrochemical, preferably single, sensor, which is shatter-proof and is designed to be used in hygienic applications.

### BACKGROUND

In analytical measurement technology, such as in the fields of water management, of environmental analysis, in industry, e.g., in food technology, biotechnology, and pharmaceutical technology, as well as for various laboratory applications, measured variables, such as the pH, the conductivity, or even the concentration of analytes, such as ions or dissolved gases in a gaseous or liquid measurement medium, are of great importance. These measurands can be captured and/or monitored, for example, by means of electrochemical sensors, such as potentiometric or amperometric sensors.

Electrochemical measuring techniques allow detection of activities of chemical substances, such as ion activities, and correlated measurands in liquids. The substance, the activity or concentration of which is to be measured, is also referred to as an analyte. The measurands that depend upon the activity of the analyte are, for example, an activity or a concentration of the analyte, e.g., of a certain ion species, or the pH value. The measuring medium can be a measuring liquid, such as an aqueous solution, emulsion, or suspension. Electrochemical measuring probes can be designed, for example, as potentiometric or amperometric sensors.

Potentiometric sensors typically comprise a measuring half-cell and a reference half-cell as well as a measurement circuit. For measurement, the measuring half-cell and the reference half-cell are brought into contact with the measuring medium. In contact with the measuring medium, the measuring half-cell forms a potential that is a function of the activity of the analyte in the measuring medium, whereas the reference half-cell provides a stable electrochemical reference potential that is independent of the analyte concentration. The measuring circuit generates an analog or digital measurement signal which represents the electric potential difference between the measuring half-cell and the reference half-cell and, consequently, the activity of the analyte in the measuring medium. The measuring signal is converted from the measurement circuit/sensor circuit and possibly output to a higher-level unit which is connected to the sensor and further processes the measuring signal. A partial or complete further processing of the measurement signal in a unit arranged in the sensor is also possible.

The reference half-cell of conventional potentiometric sensors is often adapted as a second-type electrode, e.g., as a silver/silver chloride reference electrode, and electrically conductively connected to the measurement circuit.

The measuring half-cell comprises a potential-forming sensor element which comprises an ion-selective membrane or layer, depending upon the type of the potentiometric sensor. Examples of such measuring half-cells are ion-selective electrodes. A traditional ion-selective electrode has a housing that is closed by the ion-selective membrane and accommodates an inner electrolyte that is in contact with the membrane. The ion-selective electrode also comprises a terminal lead which is in contact with the inner electrolyte. The terminal lead is electrically conductively connected to the measurement circuit. If the ion-selective membrane for measuring is in contact with the measuring medium, the membrane selectively interacts with a specific ionic species contained in the measuring medium, viz., with the analyte. Changing the activity or concentration of the ion in the measuring medium causes a relative change in the equilibrium galvanic voltage between the measuring medium and the terminal lead in contact with the ion-selective membrane via the inner electrolyte. A special case of such an ion-selective electrode, viz., an electrode that selectively detects H+ or hydronium ion activity in a measuring fluid, is the known pH glass electrode, which comprises an ion-selective glass membrane as the potential-forming sensor element.

Such ion-selective glass electrodes as well as sensors with corresponding glass electrodes generally have good measuring properties; in the case of a pH glass electrode, this relates for example to the long-term stability, selectivity, and detection limit. However, glass electrodes break easily and therefore have only low mechanical stability.

Enamel is another material used for ion-sensitive electrodes, preferably pH electrodes. Enamel electrodes usually have a metallic shaft and are as a result, may have high mechanical stability.

The main components of enamel are inorganic oxide components. Enamel is comparable to glass in terms of its properties. Base constituents are, for example, one or more of the oxides silicon oxide, sodium oxide, potassium oxide, calcium oxide, magnesium oxide, and aluminum oxide. Applied to a metal substrate, an enamel coating can achieve adhesive strengths of up to 100 N/m2.

In addition, they are chemically inert due to the enamel coating and can also be used in the case of aggressive media, such as for chemical processes, or for processes in which frequent cleaning must be performed, such as in the food industry.

Enamel electrodes are described, for example, in EP0180071B1, EP0614694B1, or WO2018/069591A1 as well. The disadvantage of enamel electrodes is that the enamel electrodes according to the prior art often cannot be integrated into conventional process fittings. This disadvantageously leads to high installation costs as well as complex calibrations and/or adjustments.

### SUMMARY

The present disclosure is based upon the object of providing an ion-selective sensor based upon enamel for an electrochemical sensor, in particular a potentiometric sensor, which is installed in a process fitting of a disposable sensor. The sensor is preferably designed for hygienic applications in the food sector—for example, in milk production, biotechnology, and/or pharmaceutical production.

A single-rod measuring cell includes a plug-in head, a shaft, and an end facing a medium during operation. The single-rod measuring cell comprises a measuring half-cell having a body, formed from an electrically conductive metal or a metal alloy, which is enclosed by a preferably circumferentially arranged ion-selective enamel layer, and an insulating enamel layer on at least the surface, in contact with the medium during operation and the electrolyte solution, of the body.

A tubular reference half-cell includes an outer shell which at least partially encloses the measuring half-cell, wherein the outer shell has at least one diaphragm, and the reference half-cell contains a reference electrode and a reference electrolyte.

In one embodiment, the single-rod measuring cell has a substantially uniform diameter from the side facing the medium up to and including the height of the at least one diaphragm, preferably a uniform diameter on the shaft.

The advantage of a uniform diameter is that the single-rod measuring cell is compatible with different fittings and is designed to be connected to different fittings.

In one embodiment of the single-rod measuring cell, the body formed from a metal or a metal alloy is tapered in the region which is enclosed by the tubular reference half-cell, wherein the body and the reference half-cell are hygienically connected to one another via a sealing element.

In one embodiment, the sealing element is designed as a sealing ring or as a diaphragm.

In one embodiment of the single-rod measuring cell, the ion-selective enamel layer is formed from a pH glass suitable for enameling.

In one embodiment of the single-rod measuring cell, the outer shell of the reference half-cell consists of a gamma radiation-sterilizable, ethylene oxide-sterilizable, and/or steam-sterilizable, preferably a gamma-sterilizable, material, more preferably a gamma-sterilizable plastic.

In one embodiment, the single-rod measuring cell is gamma radiation-sterilizable, ethylene oxide-sterilizable, and/or steam-sterilizable.

In one embodiment of the single-rod measuring cell, the measuring half-cell comprises a temperature sensor.

The present disclosure also relates to a sensor comprising the single-rod measuring cell according to the present disclosure or an embodiment thereof, wherein the sensor has a fitting that at least partially encloses, preferably coaxially encloses, the single-rod measuring cell.

In one embodiment of the sensor, the fitting comprises a first connecting element which is designed to be mechanically and hygienically connected to a measuring cell via a second connecting element, wherein the first connecting element and the second connecting element are designed as a form-fitting or an integral connection.

In one embodiment of the sensor, the form-fitting connection comprises an aseptic connector, a clamp connection, a flange connection, a snap-in connection, or a screw connection. In another embodiment, the integral connection comprises an adhesive connection or a welded connection.

In one embodiment of the sensor, the fitting comprises:
a cavity containing a storage electrolyte and
an opening at the end facing the medium during operation, wherein
   the single-rod measuring cell is arranged within the cavity of the fitting in such a way that it can be moved from a first storage position into a second measuring position and can be locked in the second measuring position via a locking element, wherein
   the ion-selective enamel layer arranged on the body and the diaphragm are wetted by the storage electrolyte in the first storage position in the cavity of the fitting, and
   in the second measuring position outside the cavity of the fitting, are wetted by a medium, wherein
   at least one seal is formed on the end, facing the medium during operation, of the electrochemical sensor between the single-rod measuring cell and the fitting in order to seal the medium to be analyzed in a liquid-tight manner from the storage electrolyte, wherein the storage electrolyte and the reference electrolyte are the same. In one embodiment of the sensor, the fitting encloses the region of the single-rod measuring cell which, in the measuring position, is not in contact with the medium to be measured.

In one embodiment, the locking takes place
via a direction reversal protection, e.g., via a thread with self-locking or a coupling with a locking geometry, or
via the plug-in head which has a suitable fixing system—for example, an axial locking ring.

The locking mechanism is designed to prevent the axial movement of the single-rod measuring cell from the measuring position back to the storage position.

In one embodiment, the sensor is designed as a hygienic sensor, preferably as a hygienic disposable sensor.

In one embodiment of the sensor, the at least one seal is designed as an O-ring.

In one embodiment of the sensor, the plug-in head comprises an electrical plug-in connector, wherein the electrical plug-in connector is electrically conductively connected to the body and to the reference electrode.

In one embodiment, the sensor is gamma-sterilizable.

Gamma sterilization is preferably carried out at 25 to 45 kGy.

In one embodiment of the sensor, the plug-in head comprises a sensor circuit, wherein the sensor circuit is electrically conductively connected to the body and to the reference electrode, wherein the sensor circuit is configured to measure a potential difference between the body and the reference electrode.

In one embodiment, the plug-in connector is electrically connected to a sensor circuit after sterilization.

In one embodiment, the sensor connected to the sensor circuit is designed to be connected to the measuring cell.

In one embodiment, after starting up the sensor,
the current flowing between the working and counter electrode is measured by the sensor circuit,
the measured current is converted into a measuring signal by the sensor circuit, and
the measurement signal is transmitted to the higher-level data processing device.

In one embodiment, the sensor is autoclavable.

In one embodiment, the sensor is sterilizable with ethylene oxide.

In one embodiment, the sensor comprises a first and a second diaphragm, wherein the first diaphragm is designed to be immersed in the medium in the second measuring position, and the second diaphragm is designed to be wetted in the second measuring position by the storage electrolyte.

The present disclosure further relates to a flow cell comprising:
(i) one module, two or more than two consecutively arranged and interconnected modules, wherein each module is designed as a flow-through measuring cell, which
(ii) in each case have an inflow and an outflow opening for a fluid, which are each assigned to a first and a second outer surface of the individual module, respectively, wherein
(iii) each module
includes a flow channel with a measuring chamber between the inflow and outflow openings,
is equipped with at least one opening for the installation of a sensor for measuring chemical and/or physical properties of a fluid flowing through the measuring cell, and at least comprises the
(iv) sensor according to the present disclosure or an embodiment thereof, wherein the sensor is arranged in a liquid-tight, preferably hygienic, manner in an individual module of the flow cell via a connection comprising a seal.

In one embodiment, the flow cell is connected on the upstream side and the downstream side of the flow cell via a fluidic connection, preferably via a hose, to a first connecting element of an aseptic adapter.

Preferably, in a modular flow cell,
in each case a uniform adapter is arranged between two successive individual modules, which adapter has a fluid-connecting passage opening and connects the flow channels of the successive individual modules to form a main line channel, wherein
the adapter has first and second opposing outer surfaces, in each case provided with second connecting elements having an axisymmetrical arrangement, wherein the first and second connecting elements are complementary to one another, wherein
each individual module can be connected with respect to another adjacent individual module by a predetermined number of orientations for an axis of symmetry about the axis of symmetry.

In one embodiment, the flow module has two, three, or four individual models. In one embodiment, a pH sensor is arranged in a single module. In one embodiment, the flow cell has a pH sensor according to the present disclosure on a single module. A conductivity sensor or a UV sensor is arranged on another individual module. In one embodiment, a conductivity module is arranged on a further individual module, and a UV sensor is arranged on a third individual module. In one embodiment, a conductivity module is arranged on a fourth individual module, a UV sensor is arranged on a third individual module, and a glucose sensor is arranged on a fourth individual module.

The present disclosure also relates to a method for starting up the sensor according to the present disclosure or an embodiment thereof, wherein
(i) the sensor is connected mechanically and gap-free to the measuring cell via the first connecting element of the sensor fitting and the second connecting element of the measuring cell, and
(ii) the sensor connected to the measuring cell is sterilized together with the measuring cell, and then
(iii) the sensor is transferred from the first storage position to the second measuring position by a movement along the longitudinal axis of the sensor.

Preferably, the measuring cell in the above-mentioned method is a flow cell according to the invention which comprises one, two, or more than two modules—for example, three or four modules. The second, the third, and the fourth modules are selected from a conductivity sensor, a UV sensor, and a glucose sensor, wherein each measuring unit comprises one sensor, and all sensors of a measuring unit are different. Sterilization is carried out by gassing with ethylene oxide, by gamma sterilization, and/or steam sterilization. Sterilization is preferably carried out by gamma sterilization.

The invention also relates to a method for starting up the sensor according to the invention
or an embodiment thereof, wherein
(i) the first connecting element is connected mechanically and gap-free to a second connecting element, wherein the second connecting element is connected mechanically and gap-free to a deformable container, preferably a bellows-shaped, flexible container,
(ii) the deformable container is connected mechanically and gap-free to a first aseptic adapter,
(iii) the sensor connected to the deformable container and the first aseptic adapter
(a) is sterilized and
(b) is connected to a sterilized measuring cell, wherein the connection is via the first aseptic adapter and a second aseptic adapter which is connected mechanically and gap-free to the measuring cell, and
(iv) the sensor is transferred from the first storage position to the second measuring position by a movement along the longitudinal axis of the sensor (L).

In one embodiment of the aforementioned method, the measuring cell is designed as a bioprocess container—for example, a bag for upstream processes or as a treatment vessel for downstream processes.

Upstream applications are understood to be the growth and cultivation of prokaryotic or eukaryotic cells on a small, medium, and large scale.

The downstream process comprises the extraction and purification of the desired product as well as bioanalytical testing and, if necessary, galenic formulation of the product. The downstream applications therefore include the necessary steps for the purification of raw biological products in order to obtain high-purity products. Such steps are, for example, cell disruption, filtration, and chromatography.

In one embodiment of the aforementioned method, the connection of a bioprocess container or a measuring cell is designed as a sealing connection, a Luer lock, a thread, a clamp connection, a flange connection, or an aseptic adapter.

The first and the second aseptic adapters form a coupling device which preferably establishes a sterile connection. Preferably, the coupling device comprises two adapters which are designed to be complementary to one another. In a preferred embodiment, it is an arrangement which comprises:
a first aseptic adapter comprising:
i. a first main body that defines a first surface and a first fluid passage therethrough;
ii. a first sealing element that is at least partially accommodated within the first main body;
iii. a first membrane that is coupled to the first surface of the first main body to cover the first sealing member;
iv. a ring adapter that is rotatable around the first main body;
v. a locking ring that is coupled to the ring adapter, wherein the locking ring is configured to couple the first aseptic coupling device to the second aseptic coupling device; and
vi. an indexing feature that indexes a rotational position of the locking ring at an indexed position and an intermediate position on the first main body;
vii, wherein the locking ring is rotatable from the indexed position to the intermediate position and from the intermediate position to a secured position, wherein at least one of the locking ring and the ring adapter further comprises at least one locking feature for preventing the locking ring and the ring adapter from rotating from the secured position to the indexed position; and
b. a second aseptic adapter comprising:
i. a second main body that defines a second surface and a second fluid passage therethrough;
ii. a second sealing element that is at least partially accommodated within the second main body;
iii. a second membrane that is coupled to the second surface to cover the second sealing element; and
iv. at least one interrupting element configured to engage the locking feature of the locking ring or ring adapter when the locking ring and ring adapter are in the secured position;
c, wherein the locking ring is rotatable from the indexed position to an intermediate position in which the first sealing element is sufficiently compressed to form a seal with the second sealing element, but still allow the first membrane and the second membrane to be removed.

Aseptic adapters or sterile adapters are connections or connectors that have been sterilized. Sterilization is carried out by gamma radiation, ethylene oxide gas, and/or autoclaving.

Hygienic, sterile, or aseptic is understood in this case to mean suitable for the production of pharmaceutical and biopharmaceutical products. Another field of application is use in food production.

All the embodiments of the sensors, the flow cell, and the method and the use described above can be combined with each other in each case, provided that this is technically possible.

### BRIEF DESCRIPTION OF THE DRAWINGS

The invention is explained in more detail in the following description with reference to the exemplary embodiments shown in the drawing.

In the figures:

FIG. 1 shows a single-rod measuring cell.

FIG. 2 shows a sensor unit comprising a single-rod measuring cell in an inactive, gamma-sterilizable state and a single-use downstream fitting.

FIG. 3 shows a sensor unit comprising a single-rod measuring cell in an activated state and a single-use downstream fitting.

### DETAILED DESCRIPTION

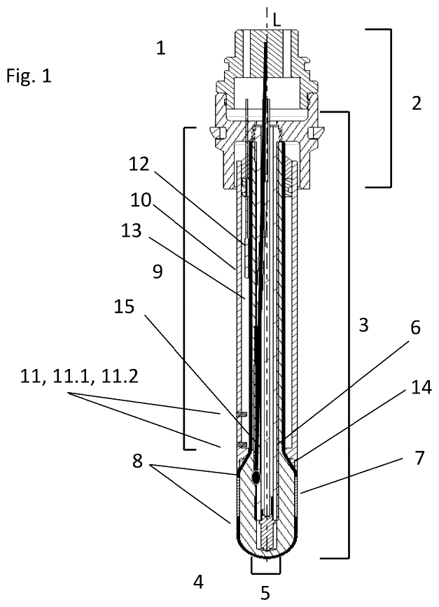

FIG. 1 shows an embodiment of the single-rod measuring cell according to the invention. The single-rod measuring cell 1 has a plug-in head 2 and a shaft 3. The single-rod measuring cell 1 has an end 4 facing the medium during operation. The single-rod measuring cell 1 comprises:
a measuring half-cell 5 that a body 6 formed from an electrically conductive metal or a metal alloy, which is enclosed by an ion-selective enamel layer 7 and an insulating enamel layer 8 at least on the surface in contact with the measuring medium during operation.

The ion-selective enamel layer 7 is arranged circumferentially around the body 6 on the end 4 facing the medium during operation. The single-rod measuring cell also comprises:
a tubular reference half-cell 9 comprising an outer shell 10, which
at least partially encloses the measuring half-cell 5, wherein
the outer shell 10 has at least one diaphragm 11, and
the reference half-cell 9 contains a reference electrode 12 and a reference electrolyte 13. The single-rod measuring cell 1 preferably has a uniform diameter in the region of the shaft 3. The single-rod measuring cell 1 is designed to be connected to a fitting 18. The fitting has an opening through which the single-rod measuring cell 1 is passed. The fitting 18 and the single-rod measuring cell 1 are connected to one another liquid-tight, preferably by arranging a sealing ring, preferably an O-ring, between the fitting 18 and the single-rod measuring cell 1.

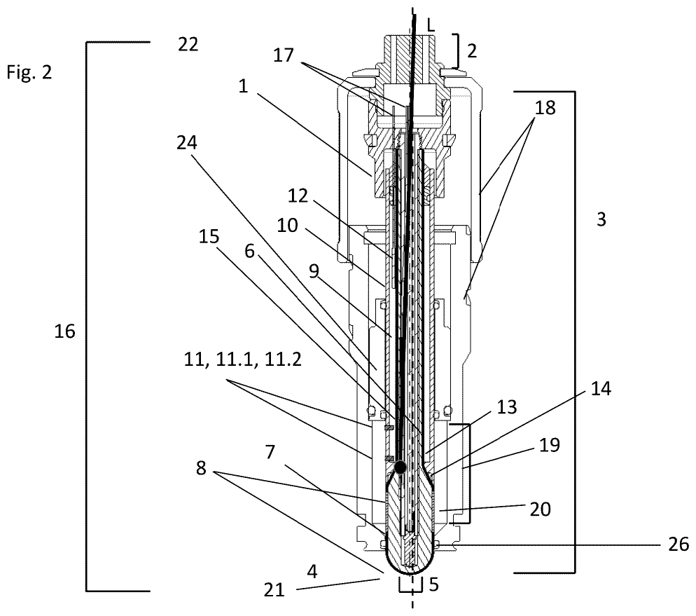

FIG. 2 shows an embodiment of the sensor 16 according to the invention comprising the single-rod measuring cell 1. The sensor 16 is in a storage position. This position is gamma-sterilizable. The sensor 16 has a plug-in head 2, a shaft 3, and an end 4 facing the medium during operation. The single-rod measuring cell 1 comprises:
a measuring half-cell 5, that a body 6 formed from an electrically conductive metal or a metal alloy, and an ion-selective enamel layer 7 arranged on the body 6, preferably circumferentially, on the end 4 facing during operation,
a tubular reference half-cell 9 comprising an outer shell 10, which
at least partially encloses the measuring half-cell 5, wherein
the reference half-cell 9 contains a reference electrode 12 and a reference electrolyte 13, and
the outer shell 10 has at least one diaphragm 11,
a sensor circuit 17 or a plug-in connection that is electrically conductively connected to the body 6 and to the reference electrode 12, wherein the sensor circuit (17) is configured to measure a potential difference between the body 6 and the reference electrode 12.

The single-rod measuring cell 1 is rotationally symmetrically enclosed by a fitting 18, wherein the fitting 18 comprises
a cavity 19 containing a storage electrolyte 20 and
an opening 21 at the end 4 facing the medium during operation, wherein
the single-rod measuring cell 1 is arranged within the cavity 19 of the fitting 18 in such a way that it can be moved from a first storage position 22 into a second measuring position 23 and can be locked in the second measuring position 23, wherein
the ion-selective enamel layer 7 arranged on the body 6 and the diaphragm 11 of the reference half-cell 6 are wetted by the storage electrolyte 20 in the first storage position 22 in the cavity 19 of the fitting 18 and,
in the second measuring position 23 outside the cavity 19 of the fitting 18, are wetted by a medium 25, wherein
at least one seal 22 is formed on at least the end 4, facing the medium during operation, of the electrochemical sensor 1 between the single-rod measuring cell 1 and the cavity 19 in order to seal the medium 25 to be analyzed from the storage electrolyte 20 in a liquid-tight manner.

The locking is done mechanically, e.g., via a thread, by snapping into recesses, provided for this purpose in the fitting, which allow only unidirectional movement in the direction of the medium.

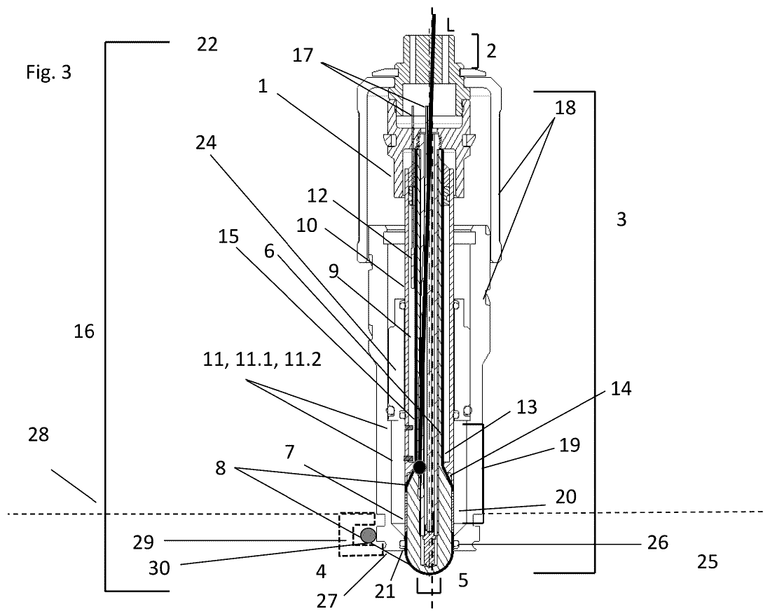

FIG. 3 shows the same embodiment of the sensor 1 according to the invention in the activated form. The ion-selective enamel layer 7 arranged on the body 6 and the diaphragm 11 of the reference half-cell 9 are wetted by a medium 25 in the second measuring position 23 outside the cavity 19 of the fitting 18. The storage electrolyte 20 is sealed liquid-tight against the medium to be analyzed.

1. A single-rod measuring cell, including:
a plug-in head;
a shaft; and
an end facing a medium during operation;
wherein the single-rod measuring cell comprises:
a measuring half-cell including a body formed from an electrically conductive metal or a metal alloy, wherein the body is enclosed by an ion-selective enamel layer and an insulating enamel layer on at least the surface of the body, in contact with the medium during operation and the electrolyte solution; and
a tubular reference half-cell comprising an outer shell which at least partially encloses the measuring half-cell wherein the outer shell has at least one diaphragm, and the reference half-cell contains a reference electrode and a reference electrolyte.

2. The single-rod measuring cell according to claim 1, wherein the single-rod measuring cell has a substantially uniform diameter from a side facing the medium up to and including a height of the at least one diaphragm.

3. The single-rod measuring cell according to claim 1, wherein the body formed from a metal or a metal alloy is tapered in a region which is enclosed by the tubular reference half-cell, wherein the body and the reference half-cell are hygienically connected to one another via a sealing element.

4. The single-rod measuring cell according to claim 3, wherein the sealing element is designed as a sealing ring or as a diaphragm.

5. The single-rod measuring cell according to claim 1, wherein the ion-selective enamel layer is formed from a pH glass which can be used for enameling.

6. The single-rod measuring cell according to claim 1, wherein the outer shell of the reference half-cell consists of a gamma radiation-sterilizable, ethylene oxide-sterilizable, and/or steam-sterilizable.

7. The single-rod measuring cell according to claim 1, wherein the measuring half-cell comprises a temperature sensor.

8. A sensor comprising the single-rod measuring cell according to claim 1, wherein the sensor has a fitting which at least partially encloses the single-rod measuring cell.

9. The sensor according to claim 8, wherein the fitting comprises a first connecting element which is designed to be mechanically and hygienically connected to a measuring cell via a second connecting element, wherein the first connecting element and the second connecting element are designed as a form-fitting or an integral connection.

10. The sensor according to claim 8, wherein the form-fitting connection comprises an aseptic connector, a clamp connection, flange connection, snap-in connection, or screw connection, and the integral connection comprises an adhesive connection or a welded connection.

11. The sensor according to claim 8, wherein the fitting comprises:
a cavity containing a storage electrolyte; and
an opening at the end facing the medium during operation, wherein:
the single-rod measuring cell is arranged within the cavity of the fitting in such a way that it can be moved from a first storage position into a second measuring position and can be locked in the second measuring position via a locking element, wherein:
the ion-selective enamel layer, arranged on the body, and the diaphragm of the reference half-cell are wetted by the storage electrolyte in the first storage position in the cavity of the fitting; and
in the second measuring position outside the cavity of the fitting, are wetted by a medium, wherein:
at least one seal is formed on at least the end, facing the medium during operation, of the electrochemical sensor between the single-rod measuring cell and the fitting in order to seal the medium to be analyzed in a liquid-tight manner from the storage electrolyte, wherein the storage electrolyte and the reference electrolyte are the same.

12. The sensor according to claim 8, wherein the sensor is designed as a hygienic sensor.

13. The sensor according to claim 11, wherein the at least one seal is designed as an O-ring.

14. The sensor according to claim 8, wherein the plug-in head comprises an electrical plug-in connector, wherein the electrical plug-in connector is electrically conductively connected to the body and to the reference electrode.

15. The sensor according to claim 8, wherein the sensor is gamma-sterilizable.

16. The sensor according to claim 8, wherein the plug-in head comprises a sensor circuit, wherein the sensor circuit is electrically conductively connected to the body and to the reference electrode, wherein the sensor circuit is configured to measure a potential difference between the body and the reference electrode.

17. The sensor according to claim 8, wherein the sensor is autoclavable and/or sterilizable with ethylene oxide.

18. The sensor according to claim 8, wherein the sensor comprises a first and a second diaphragm, wherein the first diaphragm is designed to be immersed in the medium in the second measuring position, and the second diaphragm is designed to be wetted by the storage electrolyte in the second measuring position.

19. A method for starting up a sensor, wherein
the sensor includes:
the sensor comprises a single-rod measuring cell, wherein the sensor has a fitting which at least partially encloses the single-rod measuring cell;
single-rod measuring cell, including:
a plug-in head;
a shaft; and
an end facing a medium during operation;
wherein the single-rod measuring cell comprises:
a measuring half-cell including a body formed from an electrically conductive metal or a metal alloy, wherein the body is enclosed by an ion-selective enamel layer and an insulating enamel layer on at least the surface of the body, in contact with the medium during operation and the electrolyte solution; and
a tubular reference half-cell comprising an outer shell which at least partially encloses the measuring half-cell wherein the outer shell has at least one diaphragm, and the reference half-cell contains a reference electrode and a reference electrolyte;
wherein the sensor is connected mechanically and gap-free to the measuring cell via the first connecting element of the sensor fitting and the second connecting element of the measuring cell, and
the sensor connected to the measuring cell is sterilized together with the measuring cell, preferably gamma-sterilized, and subsequently the sensor is transferred from the first storage position to the second measuring position by a movement along the longitudinal axis of the sensor.

20. The method for starting up the sensor according to claim 8, wherein:
the first connecting element is connected mechanically and gap-free to a second connecting element, wherein the second connecting element is connected mechanically and gap-free to a deformable container;
the deformable container is connected mechanically and gap-free to a first aseptic adapter;
the sensor is connected to the deformable container and the first aseptic adapter, is gamma-sterilized and is connected to a sterilized measuring cell, wherein the connection is via the first aseptic adapter and a second aseptic adapter which is connected mechanically and gap-free to the measuring cell; and
the sensor is transferred from the first storage position to the second measuring position by a movement along the longitudinal axis of the sensor.

21. The method for starting up the sensor according to claim 19, wherein the measuring cell is designed as a bioprocess container, which is fluidically connected to the bioprocess container, or as a treatment vessel for downstream processes.

22. The method for starting up the sensor according to claim 21, wherein the connection of a bioprocess container or a measuring cell is designed as a sealing connection, as a Luer lock, a thread, a clamp connection, a flange connection, or an aseptic adapter.
